(19) United States
(12) Patent Application Publication
(10) Pub. No.: US 2025/0300409 A1
(43) Pub. Date: Sep. 25, 2025

(54) Sparkproof Blade-type Electrical Connector For Drones

(71) Applicant: AVERTRONICS INC., Taichung City (TW)

(72) Inventors: Austin Lai, Taichung City (TW); Shiang Yan Chang, Taichung City (TW); Kai Yang Cheng, Taichung City (TW)

(21) Appl. No.: 19/053,362

(22) Filed: Feb. 13, 2025

(30) Foreign Application Priority Data
Mar. 21, 2024 (TW) 113202824

(51) Int. Cl. H01R 13/703; H01R 13/66

(52) U.S. Cl. CPC H01R 13/703; H01R 13/6616; H01R 2201/26

(57) ABSTRACT

A sparkproof blade-type electrical connector for drones may include a male connector and a female connector. The male connector has a connecting sleeve, and two connecting slots are formed on the connecting sleeve, and each of the connecting slots is connected to a male connecting head. The male connector comprises at least a male live line to connect to the male connecting head, and one of the two connecting slots has a first slot, and the connecting sleeve comprises an elastic plate which is coupled in the first slot. The female connector has a connecting base, and two connecting posts are formed on connecting base, and each of the connecting posts has a female connecting head formed therein. Each of the female connecting heads is equipped with a crown spring to establish contact with the male connecting head.

### FIELD OF THE INVENTION

The present invention relates to a blade-type electrical connector and more particularly to a sparkproof blade-type electrical connector for drones.

### BACKGROUND OF THE INVENTION

Drones have been widely applied in recent years across various fields such as aerial photography, agriculture, and performances, and they are even used in warfare as tools for reconnaissance and offensive operations. However, some commonly used drones lack a Battery Management System (BMS) to mange the batteries. As a result, sparks are likely to occur during connector connections, leading to shell melting and circuit board damage. The intense light and sound generated by the sparks during connector engagement can be alarming, and the high temperatures from the momentary sparks are sufficient to melt the surface of the plug, leading to oxidation and poor contact issues. Consequently, the connector plugs must be replaced periodically.

The BMS is equipped with functions to prevent abnormal conditions such as over-discharge, overcharge, and overheating of the battery. Although integrating a BMS can effectively enhance the stability and safety of drone connectors, it also increases manufacturing costs. Moreover, drones are designed to prioritize lightweight construction, so that adopting a simpler and more cost-effective methods to prevent sparks during connector engagement is essential, so as to achieve a balance in production, quality, and maintenance while maximizing the stability and safety of drones.

In addition, after prolonged use, connectors must allow for easy plugging and unplugging while improving their reliability, reducing the probability of poor contact, and helping maintain the quality thereof. Therefore, there remains a need for a new and improved design for a sparkproof blade-type electrical connector for drones to overcome the problems presented above.

### SUMMARY OF THE INVENTION

The present invention provides a sparkproof blade-type electrical connector for drones comprising a male connector and a female connector. The male connector has a connecting sleeve, and two connecting slots are formed on the connecting sleeve, and each of the connecting slots is connected to a male connecting head. The male connector comprises at least a male live line to connect to the male connecting head, and one of the two connecting slots has a first slot, and the connecting sleeve comprises an elastic plate which is coupled in the first slot. The female connector has a connecting base, and two connecting posts are formed on connecting base, and each of the connecting posts has a female connecting head formed therein. Each of the female connecting heads is equipped with a crown spring to establish contact with the male connecting head. The female connector has at least a female live line to connect to the female connecting head, and a switch blade penetrating through the connecting base is positioned between the two connecting posts. One of the two connecting posts comprises a flange protruding from the lateral side thereof to couple with the switch blade, and the elastic plate and the switch blade are respectively connected to the male live line and the female live line. A resistor is connected between the elastic plate and the male live line or between the switch blade and the female live line. When the male connector is connected to the female connector, the connecting posts are engaged into the connecting slots, and the flange is positioned into the first slot. The horizontal position of the front end of the switch blade protrudes further than the crown spring between the front end of the crown spring and the front end of the connecting post, so that the switch blade is adapted to contact the elastic plate first. The male live line and the female live line are connected, and the resistor is configured to reduce the instantaneous current passing therethrough, thereby preventing the generation of sparks. The male connecting head is inserted into the female connecting head, making contact with the crown spring for electrical conduction, and the flange is abutted against the switch blade to ensure the switch blade to firmly make contact with the elastic plate, thereby completing the mating of the male connector and the female connector to transmit current.

In one embodiment, the resistor is positioned between the switch blade and the female live line.

In another embodiment, the resistor is positioned between the elastic plate and the male live line.

Comparing with conventional electrical connector for drones, the present invention is advantageous because: When the male connector is connected to the female connector, the switch blade is configured to have contact with the elastic plate first so as to connect the male live line with the female live line, and the resistor is adapted to reduce the instantaneous current passing through to prevent the generation of sparks. Then, the present invention can prevent sparks from damaging the male connector and the female connector, thereby easily and cost-effectively enhancing the stability and safety of the male connector and the female connector.

### BRIEF DESCRIPTION OF THE DRAWINGS

FIG. 1 is a three-dimensional assembly view of a sparkproof blade- type electrical connector for drones of the present invention.

FIG. 2 is a three-dimensional exploded view of the sparkproof blade-type electrical connector for drones of the present invention.

FIG. 3 is a schematic view illustrating a male connector is connected to a female connector of the sparkproof blade-type electrical connector for drones in the present invention.

FIG. 4 is a top sectional view illustrating the male connector and the female connector of the sparkproof blade-type electrical connector for drones of the present invention are not connected.

FIG. 5 is a top sectional view illustrating a switch blade and an elastic plate of the sparkproof blade-type electrical connector for drones of the present invention are connected first.

FIG. 6 is a partial enlarged view illustrating the switch blade and the elastic plate of the sparkproof blade-type electrical connector for drones of the present invention are connected first.

FIG. 7 is a top sectional view illustrating the male connector and the female connector of the sparkproof blade-type electrical connector for drones of the present invention are connected.

FIG. 8 is a top sectional view of another embodiment of the sparkproof blade-type electrical connector for drones of the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

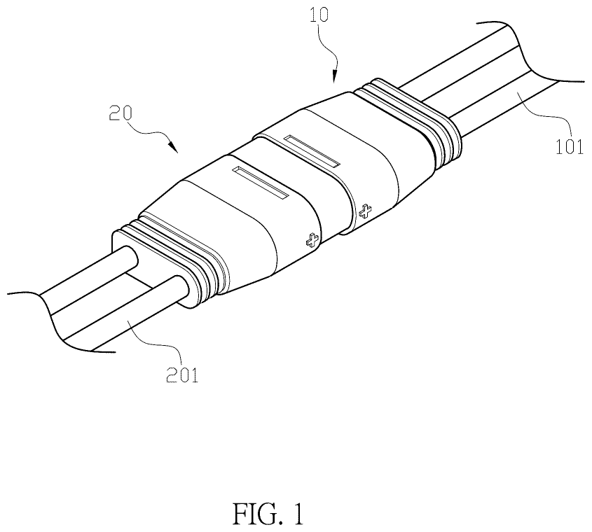

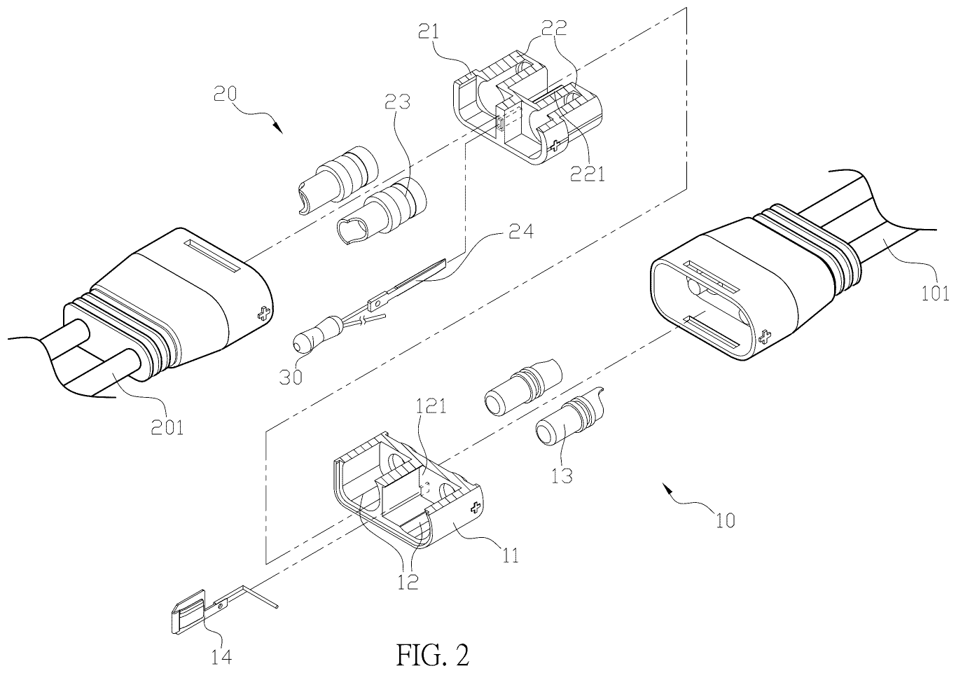

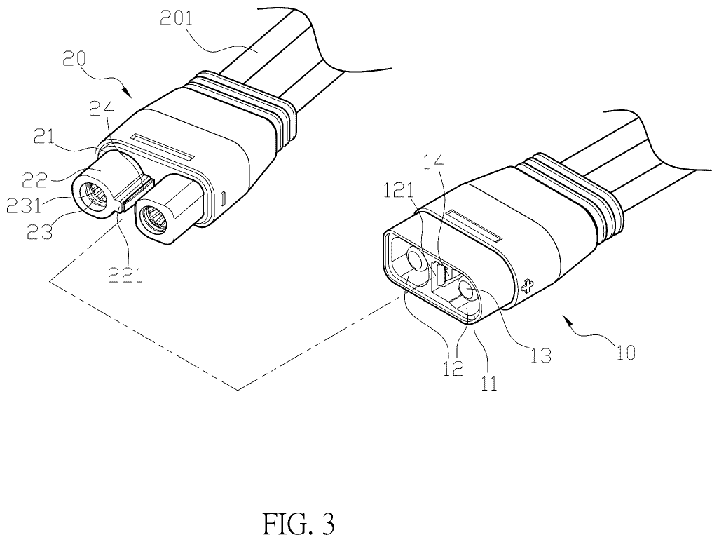

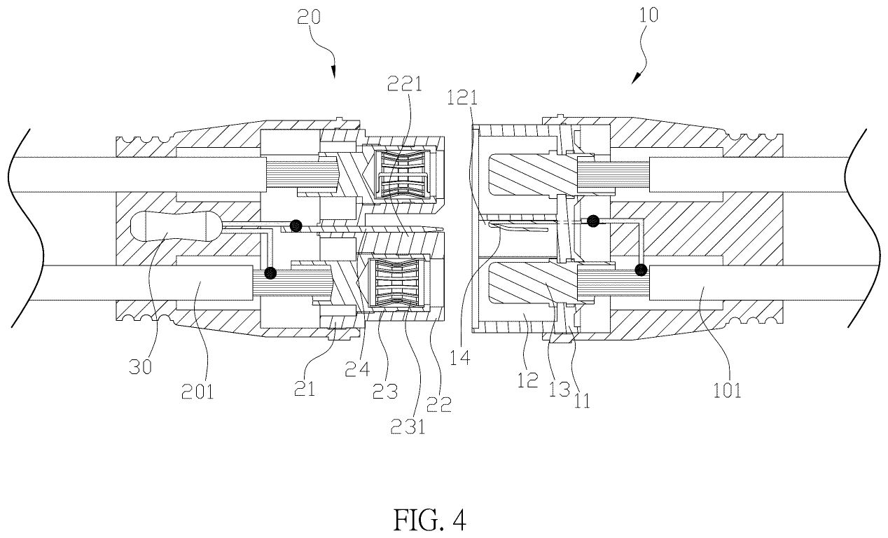

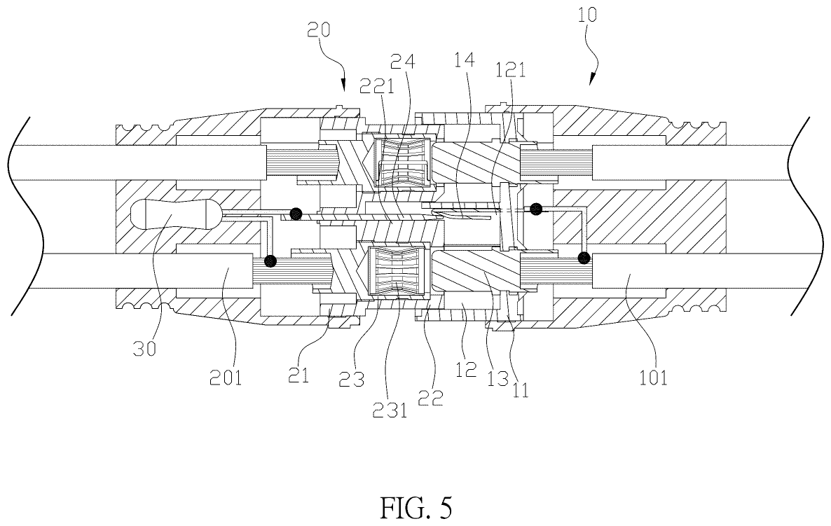

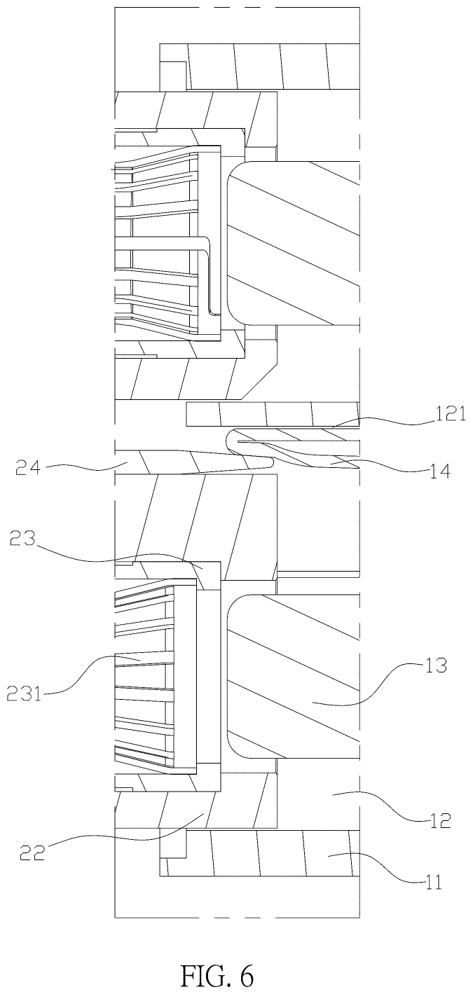

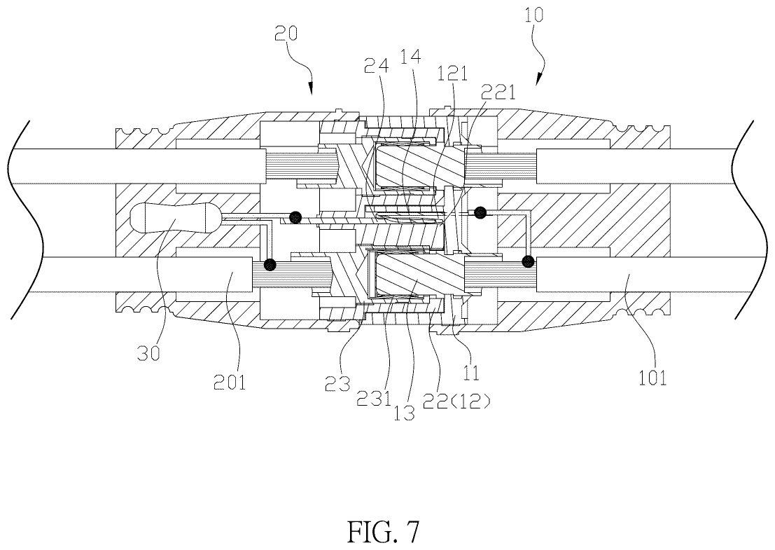

Referring to FIGS. 1 to 4, the present invention provides a sparkproof blade-type electrical connector for drones comprising a male connector (10) and a female connector (20). The male connector (10) has a connecting sleeve (11), and two connecting slots (12) are formed on the connecting sleeve (11), and each of the connecting slots (12) is connected to a male connecting head (13). Also, the male connector (10) comprises at least a male live line (101) to connect to the male connecting head (13), and one of the two connecting slots (12) has a first slot (121), and the connecting sleeve (11) comprises an elastic plate (14) which is coupled in the first slot (121). The female connector (20) has a connecting base (21), and two connecting posts (22) are formed on connecting base (21), and each of the connecting posts (22) has a female connecting head (23) formed therein. In addition, each of the female connecting heads is equipped with a crown spring (231) to establish contact with the male connecting head (13). The female connector (20) has at least a female live line (201) to connect to the female connecting head (23), and a switch blade (24) penetrating through the connecting base (21) is positioned between the two connecting posts (22). Moreover, one of the two connecting posts (22) comprises a flange (221) protruding from the lateral side thereof to couple with the switch blade (24), and the elastic plate (14) and the switch blade (24) are respectively connected to the male live line (101) and the female live line (201). Also, a resistor (30) is connected between the elastic plate (14) and the male live line (101) or between the switch blade (24) and the female live line (201). Referring to FIGS. 5 to 7, when the male connector (10) is connected to the female connector (20), the connecting posts (22) are engaged into the connecting slots (12), and the flange (221) is positioned into the first slot (121). Furthermore, the horizontal position of the front end of the switch blade (24) protrudes further than the crown spring (231) between the front end of the crown spring (231) and the front end of the connecting post (22), so that the switch blade (24) is adapted to contact the elastic plate (14) first. Also, the flange (221) is abutted against the switch blade (24) to ensure the switch blade (24) to firmly make contact with the elastic plate (14), so that the male live line (101) and the female live line (201) are connected, and the resistor (30) is configured to reduce the instantaneous current passing therethrough, thereby preventing the generation of sparks. Thereafter, the male connecting head (13) is inserted into the female connecting head (23), making contact with the crown spring (231) for electrical conduction, thereby completing the mating of the male connector (10) and the female connector (20) to transmit current.

When the male connector (10) is connected to the female connector (20), the switch blade (24) is configured to have contact with the elastic plate (14) first so as to connect the male live line (101) with the female live line (201), and the resistor (30) is adapted to reduce the instantaneous current passing through to prevent the generation of sparks. Then, the present invention can prevent sparks from damaging the male connector (10) and the female connector (20), thereby easily and cost-effectively enhancing the stability and safety of the male connector (10) and the female connector (20).

Additionally, the use of the switch blade (24) in combination with the elastic plate (14) for contact and connection makes the process of connecting and disconnecting easier, while also improving reliability, reducing the likelihood of poor contact, and increasing durability. This further enhances the stability and safety of the male connector and the female connector (20). The flange (221) abutted against the switch blade (24) is adapted to support the switch blade (24) and the elastic plate (14) in contact, ensuring that both components are properly engaged.

Moreover, the horizontal position of the front end of the switch blade (24) protrudes further than the crown spring (231) between the front end of the crown spring (231) and the front end of the connecting post (22), so that the switch blade (24) is adapted to contact the elastic plate (14) first, thus preventing the user from accidentally touching the switch blade (24) and increasing safety during use.

In one embodiment, referring to FIGS. 1 to 7, the resistor (30) is positioned between the switch blade (24) and the female live line (201).

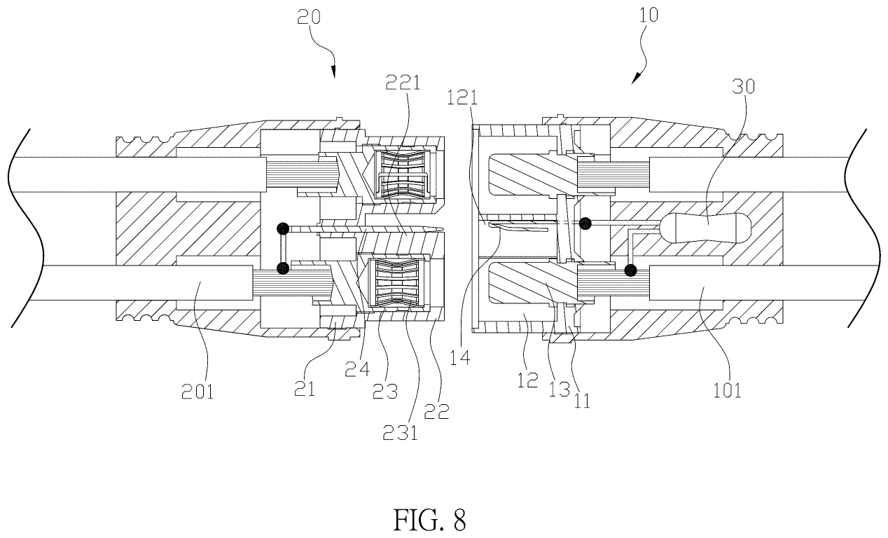

In another embodiment, referring to FIG. 8, the resistor (30) is positioned between the elastic plate (14) and the male live line (101).

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A sparkproof blade-type electrical connector for drones comprising a male connector and a female connector;
wherein the male connector has a connecting sleeve, and two connecting slots are formed on the connecting sleeve, and each of the connecting slots is connected to a male connecting head; the male connector comprises at least a male live line to connect to the male connecting head, and one of the two connecting slots has a first slot, and the connecting sleeve comprises an elastic plate which is coupled in the first slot; the female connector has a connecting base, and two connecting posts are formed on connecting base, and each of the connecting posts has a female connecting head formed therein; each of the female connecting heads is equipped with a crown spring to establish contact with the male connecting head; the female connector has at least a female live line to connect to the female connecting head, and a switch blade penetrating through the connecting base is positioned between the two connecting posts; one of the two connecting posts comprises a flange protruding from the lateral side thereof to couple with the switch blade, and the elastic plate and the switch blade are respectively connected to the male live line and the female live line; a resistor is connected between the elastic plate and the male live line or between the switch blade and the female live line; when the male connector is connected to the female connector, the connecting posts are engaged into the connecting slots, and the flange is positioned into the first slot; the horizontal position of the front end of the switch blade protrudes further than the crown spring between the front end of the crown spring and the front end of the connecting post, so that the switch blade is adapted to contact the elastic plate first, and the male live line and the female live line are connected, and the resistor is configured to reduce the instantaneous current passing therethrough, thereby preventing the generation of sparks; the male connecting head is inserted into the female connecting head, making contact with the crown spring for electrical conduction, and the flange is abutted against the switch blade to ensure the switch blade to firmly make contact with the elastic plate, thereby completing the mating of the male connector and the female connector to transmit current.

2. The sparkproof blade-type electrical connector for drones of claim 1, wherein the resistor is positioned between the switch blade and the female live line.

3. The sparkproof blade-type electrical connector for drones of claim 1, wherein the resistor is positioned between the elastic plate and the male live line.
